(19) United States
(12) Patent Application Publication
(10) Pub. No.: US 2019/0382656 A1
(43) Pub. Date: Dec. 19, 2019

(54) SEMICONDUCTOR NANOSIZED MATERIAL

(71) Applicant: MERCK PATENT GMBH, DARMSTADT (DE)

(72) Inventors: David MOCATTA, Gadera (IL); Amir HOLTZMAN, Rehovot (IL); Nina LIDICH, Jerusalem (IL); Yael NISENHOLZ, Jerusalem (IL)

(73) Assignee: MERCK PATENT GMBH, DARMSTADT (DE)

(21) Appl. No.: 16/485,012

(22) PCT Filed: Feb. 7, 2018
(86) PCT No.: PCT/EP2018/053009

§ 371 Date: Aug. 9, 2019

Related U.S. Application Data
(60) Provisional application No. 62/467,428, filed on Mar. 6, 2017.

(30) Foreign Application Priority Data
Feb. 10, 2017 (EP) 17155741.6

(51) Int. Cl. C09K 11/70; C01B 25/08; C09K 11/08; C09K 11/02

(52) U.S. Cl. CPC C09K 11/70; C01B 25/087; C09K 11/0883; C09K 11/025; B82Y 20/00; C01P 2006/60; C01P 2004/64; C01P 2004/52; C01P 2006/40

(57) ABSTRACT

The present invention relates to a method for synthesizing a semiconductor material.

### FIELD OF THE INVENTION

The present invention relates to a method for synthesizing III-V semiconductor nanosized materials, a plurality of III-V semiconductor nanosized materials obtainable or obtained from the method, a semiconductor light emitting nanosized material, a composition comprising a semiconductor light emitting nanosized material, an optical medium comprising a semiconductor light emitting nanosized material, and an optical device comprising an optical medium.

### BACKGROUND ART

Several methods for synthesizing semiconductor nanosized materials are known in the prior art.

For example, as described in X. Yang et al., Adv. Mater., 2012, 24, 4180, L. Li & P. Reiss, JACS, 2008, 130, 1589, M. Tessier, Chem. Mater., 2015, 27, 4893, U.S. Pat. No. 7,964,278 B2, U.S. Pat. No. 8,343,576 B2, US 2010/0123155 A1, D. Gary et al., Chem. Mater. 2015, 27, 1432-1441.

### Patent Literature

1. U.S. Pat. No. 7,964,278 B2

2. U.S. Pat. No. 8,343,576 B2,

3. US 2010/0123155 A1

### Non Patent Literature

4. X. Yang et al., Adv. Mater., 2012, 24, 4180,

5. L. Li & P. Reiss, JACS, 2008, 130, 1589,

6. M. Tessier, Chem. Mater., 2015, 27, 4893,

7. D. Gary et al., Chem. Mater. 2015, 27, 1432-1441,

### SUMMARY OF THE INVENTION

However, the inventor newly has found that there are still one or more of considerable problems for which improvement is desired, as listed below.

1. A novel method for synthesizing III-V semiconductor nanosized materials without directly using the highly reactive tris(trimethylsilyl)phosphine, is desired.

2. A novel method for synthesizing III-V semiconductor nanosized materials, which can produce III-V semiconductor nanosized materials with improved size distribution, is required.

3. A novel method for synthesizing III-V semiconductor nanosized materials without directly using the highly reactive tris(trimethylsilyl)phosphine, over which there is control of the particle size over a larger range such that green and/or red III-V semiconductor nanosized materials with improved size distribution can be produced, is desired.

4. A novel semiconductor light emitting nanosized material, which can emit light with better Full Width at Half Maximum (FWHM), is requested.

5. A novel semiconductor light emitting nanosized material, which can show improved quantum yield, is desired.

6. An optical display device, whose optically active component is a semiconductor light emitting nanosized material, that gives an improved color purity and color gamut, is requested.

The inventor aimed to solve one or more of the above-mentioned problems 1 to 6.

It was found that a novel method for synthesizing a III-V semiconductor nanosized material, wherein the method comprises following steps,

(a) providing either a III-V semiconductor nanosized cluster and a first ligand at the same time or each separately,

or a III-V semiconductor nanosized cluster comprising a second ligand wherein the content of said second ligand is in the range from 40% to 80% by weight, more preferably in the range from 50% to 70% by weight, even more preferably from 55% to 65% by weight with respect to the total weight of the III-V semiconductor nanosized cluster,

to an another compound or to an another mixture of compounds, in order to get a reaction mixture,

(b) adjusting or keeping the temperature of the reaction mixture obtained in step (a) in the range from 250° C. to 500° C., with preferably being of the temperature in the range from 280° C. to 450° C., more preferably it is from 300° C. to 400° C., further more preferably from 320° C. to 380° C. to allow a creation and growth of a III-V semiconductor nanosized material in the mixture.

(c) cooling the reaction mixture to stop the growth of said III-V semiconductor nanosized material in step (b).

In another aspect, the present invention relates to a III-V semiconductor nanosized material obtainable or obtained from the method.

In another aspect, the present invention further relates to a plurality of III-V semiconductor nanosized materials with the diameter standard deviation 13% or less, with preferably being of the diameter standard deviation in the range from 10% or less, more preferably it is from 10% to 1%, even more preferably, from 10% to 5%.

In another aspect, the present invention furthermore relates to a semiconductor light emitting nanosized material comprising the III-V semiconductor nanosized material and a shell layer, preferably the shell layer consists of single shell layer, double shell layers or multi shell layers.

In another aspect, the present invention also relates to a composition comprising the semiconductor light emitting nanosized material, and at least one other material selected from the group consisting of organic light emitting materials, inorganic light emitting materials, charge transporting materials, scattering particles, and matrix materials.

In another aspect, the present invention further relates to formulation comprising the semiconductor light emitting material or the composition, and a solvent.

In another aspect, the present invention relates to an optical medium comprising the semiconductor light emitting nanosized material.

In another aspect, the present invention relates to an optical device comprising the optical medium.

### DESCRIPTION OF DRAWINGS

FIG. 1: shows histogram of the relative size distribution of semiconductor nanosized materials obtained in working example 1.

### DETAILED DESCRIPTION OF THE INVENTION

Method for Synthesizing III-V Semiconductor Nanosized Materials

According to the present invention, said method for a synthesizing III-V semiconductor nanosized material comprises following steps,

(a) providing either a III-V semiconductor nanosized cluster and a first ligand at the same time or each separately,

or a III-V semiconductor nanosized cluster comprising a second ligand wherein the content of said second ligand is in the range from 40% to 80% by weight, more preferably in the range from 50% to 70% by weight, even more preferably from 55% to 65% by weight with respect to the total weight of the III-V semiconductor nanosized cluster,

to an another compound or to an another mixture of compounds, in order to get a reaction mixture,

(b) adjusting or keeping the temperature of the reaction mixture obtained in step (a) in the range from 250° C. to 500° C., with preferably being of the temperature in the range from 280° C. to 450° C., more preferably it is from 300° C. to 400° C., further more preferably from 320° C. to 380° C. to allow a creation and growth of a III-V semiconductor nanosized material in the mixture.

(c) cooling the reaction mixture to stop the growth of said III-V semiconductor nanosized material in step (b).

In some embodiments of the present invention, wherein the cooling rate in step (c) is in the range from 130° C./s to 5° C./s, preferably it is from 120° C./s to 10° C./s, more preferably it is from 110° C./s to 50° C./s, even more preferably it is from 100° C./s to 70° C./s.

According to the present invention, the term “III-V semiconductor” means a semiconductor material mainly consisting of one or more of group 13 elements of the periodic table and one or more of group 15 elements of the periodictable.

According to the present invention, the term “cluster” means a group of atoms or molecules.

According to the present invention, the term “ligand” means an ion or molecule that binds to a central metal atom to form a coordination complex or to a metal atom or cation on the surface of quantum materials. Some ligands may also bind to anions on the surface of the quantum materials.

In some embodiments of the present invention, the first ligand, the second ligand and the third ligand are, independently or dependently of each other, selected from one or more members of the group consisting of carboxylic acids, metal carboxylate ligands, phosphines, phosphonic acids, metal-phosphonates, amines, quaternary ammonium carboxylate salts, metal phosphonates and metal halides, with preferably being of myristic acid, lauric acid, stearate, oleate, myristate, laurate, phenyl acetate indium myristate, or indium acetate.

Here, carboxylic acids include but are not limited to: hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, icosanoic acid, with preferably being of myristic acid, lauric acid, stearic acid, oleic acid, phenyl acetic acid. Metal carboxylate ligands where the metal is preferably group III or II metal atom of the periodic table. More preferably, it is indium, gallium, or zinc. Furthermore, preferably it is Indium or zinc. Moreover, where the carboxylate group includes but is not limited to hexanoate, heptanoate, octanoate, nonanoate, decanoate, undecanoate, dodecanoate, tridecanoate, tetradecanoate, pentadecanoate, hexadecanoate, heptadecanoate, octadecanoate, nonadecanoate, icosanoate and oleate. Preferably being indium myristate, indium laurate, indium stearate, indium oleate. Amines such as hexylamine, heptylamine, octylamine, nonylamine, decylamine, undecylamine, dodecylamine, tridecylamine, tetradcylamine, pentadecylamine, hexadecylamine, heptadecylamine, octadecylamine, oleylamine, di-hexylamine, di-heptylamine, di-octylamine, di-nonylamine, di-decylamine, di-undecylamine, di-dodecylamine, di-tridecylamine, di-tetradcylamine, di-pentadecylamine, di-hexadecylamine, di-heptadecylamine, di-octadecylamine, tri-hexylamine, tri-heptylamine, tri-octylamine, tri-nonylamine, tri-decylamine, tri-undecylamine, tri-dodecylamine, tri-tridecylamine, tri-tetradcylamine, tri-pentadecylamine, tri-hexadecylamine, tri-heptadecylamine, tri-octadecylamine. Preferably being octylamine, oleylamine, dodecylamine. Phosphines such as tri-octylphosphine, tri-butylphosphine; Phosphonates-octadecylphosphonate, hexadecylphosphonate, phenylphosponate, Preferably being indium octadecylphosponate

As well as quaternary ammonium carboxylate salts such as tetrabutylammonium myristate or tetrabutylammonium carboxylate where the carboxylate is any of, but not limited to, the following; hexanoate, heptanoate, octanoate, nonanoate, decanoate, undecanoate, dodecanoate, tridecanoate, tetradecanoate, pentadecanoate, hexadecanoate, heptadecanoate, octadecanoate, nonadecanoate, icosanoate and oleate. Preferably tetrabutylammonium myristate and myristate and tetraoctylammonium myristate.

In a preferred embodiment of the present invention, the first, second and third ligands can be same.

In some embodiments, alkyl chain lengths of said phosphonates, carboxylic acids, carboxylate anions,amines and quaternary ammonium salts can be C1 to C18, and the chain can be linear or branched.

More preferably, the first ligand, the second ligand and the third ligand are selected from myristic acid, or indium-myristate or a combination of myristic acid and indium-myristate.

In a preferred embodiment of the present invention, in step (a), a plurality of the first ligands, the second ligands and/or a plurality of the third ligands are provided.

In some embodiments of the present invention, said another compound is a solvent.

In some embodiments of the present invention, said another compound is a solvent having the boiling point 250° C. or more, with preferably being of the boiling point in the range from 250° C. to 500° C., more preferably it is in the range from 300° C. to 480° C., even more preferably from 350° C. to 450° C., further more preferably it is from 370° C. to 430° C.

In some embodiments of the present invention, said another compound is a solvent selected from one or more members of the group consisting of squalenes, squalanes, heptadecanes, octadecanes, octadecenes, nonadecanes, icosanes, henicosanes, docosanes, tricosanes, pentacosanes, hexacosanes, octacosanes, nonacosanes, triacontanes, hentriacontanes, dotriacontanes, tritriacontanes, tetratriacontanes, pentatriacontanes, hexatriacontanes, oleylamines, and trioctylamines, with preferably being of squalene, squalane, heptadecane, octadecane, octadecene, nonadecane, icosane, henicosane, docosane, tricosane, pentacosane, hexacosane, octacosane, nonacosane, triacontane, hentriacontane, dotriacontane, tritriacontane, tetratriacontane, pentatriacontane, hexatriacontane, oleylamine, and trioctylamine, more preferably squalane, pentacosane, hexacosane, octacosane, nonacosane, or triacontane, even more preferably squalane, pentacosane, or hexacosane.

In some embodiments, alkyl chain lengths of said solvent can be C1 to C30, and the chain can be linear or branched.

In some embodiments of the present invention, said another mixture of compounds can be a mixture of said solvents, a mixture of one or more of said solvent and one or more of the first ligands, a mixture of one or more of said solvent and one or more of said III-V semiconductor nanosized clusters, or a mixture of one or more of said solvent, one or more of said ligands and one or more of said III-V semiconductor nanosized clusters.

In some embodiments of the present invention, the total amount of the ligand added in step (a) is in the range from 0.2 to 50% by weight, with preferably being of 0.3 to 50% by weight, more preferably, 1-50% by weight, even more preferably, from 1 to 25% by weight, further more preferably it is from 5-25% by weight with respect to total weight of the reaction mixture.

In some embodiments of the present invention, the III-V semiconductor nanosized cluster, which is provided with the first ligand in step (a), comprises a third ligand wherein the content of said third ligand is in the range from 40% to 80% by weight, more preferably in the range from 50% to 70% by weight, even more preferably from 55% to 65% by weight with respect to the total weight of the III-V semiconductor nanosized cluster. If you apply the core cleaning process disclosed in the section of “Core cleaning process”, the content of said second and third ligand can be adjusted.

In some embodiments of the present invention, wherein the temperature of the mixture in step (b) is kept for from 1 second to 15 minutes with being more preferably from 1 second to 14 minutes, even more preferably, from 10 seconds to 12 minutes, further more preferably, from 10 seconds to 10 minutes, even more preferably, from 10 seconds to 5 minutes, the most preferably, from 10 seconds to 120 seconds.

In some embodiments of the present invention, the total amount of the inorganic part of said III-V semiconductor nanosized clusters can be in the range from 0.1×10⁻⁴ to 1×10⁻³ mol %, with preferably being of the amount in the range from 0.5×10⁻⁴ to 5×10⁻⁴ mol %, more preferably from 1×10⁻⁴ to 3×10⁻⁴ mol % of the reaction mixture.

In some embodiments of the present invention, the total amount of the inorganic part of said III-V semiconductor nanosized clusters can be in the range from 0.1×10⁻⁴ to 1×10⁻³ molar, with preferably being of the amount in the range from 0.5×10⁻⁴ to 5×10⁻⁴ molar, more preferably from 1×10⁻⁴ to 3×10⁻⁴ molar, with respect to 1 molar of the reaction mixture.

According to the present invention, injection process of the ligands and the III-V semiconductor nanosized clusters to said mixture can be vary.

For example, the ligands and the III-V semiconductor nanosized clusters can be provided directly into said mixture at the same time in step (a),

Thus, in some embodiments of the present invention, the first ligand and the III-V semiconductor nanosized cluster are provided to the another compound or to the another mixture of compounds at the same time in step (a).

In some embodiments of the present invention, said step (a) comprises following steps (a1) and (a2),

(a1) preparing a first mixture by mixing the first ligand and the III-V semiconductor nanosized cluster with an another compound or with an another mixture of compounds,

(a2) mixing the first mixture obtained in step (a1) with an another compound or with an another mixture at the temperature in the range between from 250° C. to 500° C., with preferably being of the temperature in the range from 280° C. to 450° C., more preferably it is from 300° C. to 400° C., further more preferably from 320° C. to 380° C. in order to get the reaction mixture.

In some embodiments of the present invention, the ligand and the III-V semiconductor nanosized cluster are provided into said another compound or into said another mixture separately in step (a), and the step (a) comprises following steps (a3) and (a4).

(a3) providing the first ligand into said another compound or into said another mixture of compounds,

(a4) providing the III-V semiconductor nanosized cluster into said another compound or into said another mixture of compounds in order to get the reaction mixture.

In some embodiments of the present invention, the ligand and the III-V semiconductor nanosized cluster are provided into said another compound or into said another mixture separately in step (a), and the step (a) comprises following steps (a3) and (a4) in this sequence.

(a3) providing the first ligand into said another compound or into said another mixture of compounds,

(a4) providing the III-V semiconductor nanosized cluster into said another compound or into said another mixture of compounds in order to get the reaction mixture.

In some embodiments of the present invention, the ligand and the III-V semiconductor nanosized cluster are provided into said another compound or into said another mixture separately in step (a), and the step (a) comprises following steps (a4) and (a3) in this sequence.

(a4) providing the III-V semiconductor nanosized cluster into said another compound or into said another mixture of compounds,

(a3) providing the first ligand into said another compound or into said another mixture of compounds in order to get the reaction mixture.

In some embodiment of the present invention, said steps (a3) and/or (a4) can be repeated.

In some embodiments of the present invention, said III-V semiconductor nanosized cluster is a III-V magic sized cluster selected from the group consisting of InP, InAs, InSb, GaP, GaAs, and GaSb, InGaP, InPAs, InPZn magic sized clusters, with preferably being of InP magic sized cluster, more preferably, it is In₃₇P₂₀R¹₅₁.

According to the present invention, the term “magic sized clusters” means nanosized clusters which potential energy is lower than another nanosized clusters as described in J. Am. Chem. Soc. 2016, 138, 1510-1513, Chem. Mater. 2015, 27, 1432-1441, Xie, R. et al., J. Am. Chem. Soc., 2009, 131 (42), pp 15457-1546.

More preferably, said R¹ of said In₃₇P₂₀R¹₅₁ is —O₂CCH₂Phenyl, a substituted or unsubstituted fatty acid such as hexanoate, heptanoate, octanoate, nonanoate, decanoate, undecanoate, dodecanoate, tridecanoate, tetradecanoate, pentadecanoate, hexadecanoate, heptadecanoate, octadecanoate, nonadecanoate, icosanoate or oleate.

In some embodiments, said fatty acid can be branched or straight.

Even more preferably, said In₃₇P₂₀R¹₅₁ is In₃₇P₂₀(O₂CR²)₅₁ selected from the group consisting of In₃₇P₂₀(O₂CCH₂Phenyl)₅₁, In₃₇P₂₀(O₂C₆H₁₁)₅₁, In₃₇P₂₀(O₂C₇H₁₃)₅₁, In₃₇P₂₀(O₂C₈H₁₅)₅₁, In₃₇P₂₀(O₂C₉H₁₇)₅₁, In₃₇P₂₀(O₂C₁₀H₁₉)₅₁, In₃₇P₂₀(O₂C₁₁H₂₁)₅₁, In₃₇P₂₀(O₂C₁₂H₂₃)₅₁, In₃₇P₂₀(O₂C₁₃H₂₅)₅₁, In₃₇P₂₀(O₂C₁₄H₂₇)₅₁, In₃₇P₂₀(O₂C₁₅H₂₉)₅₁, In₃₇P₂₀(O₂O₁₆H₃₁)₅₁, In₃₇P₂₀(O₂C₁₇H₃₃)₅₁, In₃₇P₂₀(O₂C₁₈H₃₅)₅₁, In₃₇P₂₀(O₂C₁₉H₃₇)₅₁, In₃₇P₂₀(O₂C₂₀H₃₉)₅₁, and In₃₇P₂₀(O₂C1₈H₃₃)₅₁.

Said III-V semiconductor nanosized clusters can be obtained with known method described for example in Dylan C Gary, J. Am. Chem. Soc 2016, 138, 1510-1513, D. Gary et al., Chem. Mater. 2015, 27, 1432-1441.

In a preferred embodiments of the present invention, a plurality of III-V semiconductor nanosized clusters are provided in step (a).

In some embodiments of the present invention, said III-V semiconductor nanosized cluster comprises a ligand selected from the group consisting of carboxylates, such as, but not limited to, myristate, phenyl acetate laurate, oleate, stearate hexanoate, heptanoate, octanoate, nonanoate, decanoate, undecanoate, dodecanoate, tridecanoate, tetradecanoate, pentadecanoate, hexadecanoate, heptadecanoate, octadecanoate, nonadecanoate, icosanoate; amines such as, but not limited to, hexylamine, heptylamine, octylamine, nonylamine, decylamine, undecylamine, dodecylamine, tridecylamine, tetradcylamine, pentadecylamine, hexadecylamine, heptadecylamine, octadecylamine, oleylamine, di-hexylamine, di-heptylamine, di-octylamine, di-nonylamine, di-decylamine, di-undecylamine, di-dodecylamine, di-tridecylamine, di-tetradcylamine, di-pentadecylamine, di-hexadecylamine, di-heptadecylamine, di-octadecylamine, tri-hexylamine, tri-heptylamine, tri-octylamine, tri-nonylamine, tri-decylamine, tri-undecylamine, tri-dodecylamine, tri-tridecylamine, tri-tetradcylamine, tri-pentadecylamine, tri-hexadecylamine, tri-heptadecylamine, tri-octadecylamine; phosphines such as, but not limited to tri-octylphosphine, tri-butylphosphine; and phosphonates-octadecylphosphonate, hexadecylphosphonate, phenylphosponate. More preferably myristate, stearate, laurate and oleic acid.

Thus, in some embodiments of the present invention, said III-V semiconductor nanosized cluster comprises a ligand selected from the group consisting of carboxylates, amines, phosphines, and phosphonates, with being more preferably carboxylates or amines.

In a preferred embodiment of the present invention, said III-V semiconductor nanosized cluster comprises a ligand selected from the group consisting of carboxylates which include but are not limited to hexanoate, heptanoate, octanoate, nonanoate, decanoate, undecanoate, dodecanoate, tridecanoate, tetradecanoate, pentadecanoate, hexadecanoate, heptadecanoate, octadecanoate, nonadecanoate, icosanoate and oleate, more preferably myristate, phenyl acetate laurate, oleate, stearate; amines hexylamine, heptylamine, octylamine, nonylamine, decylamine, undecylamine, dodecylamine, tridecylamine, tetradcylamine, pentadecylamine, hexadecylamine, heptadecylamine, octadecylamine, oleylamine, di-hexylamine, di-heptylamine, di-octylamine, di-nonylamine, di-decylamine, di-undecylamine, di-dodecylamine, di-tridecylamine, di-tetradcylamine, di-pentadecylamine, di-hexadecylamine, di-heptadecylamine, di-octadecylamine, tri-hexylamine, tri-heptylamine, tri-octylamine, tri-nonylamine, tri-decylamine, tri-undecylamine, tri-dodecylamine, tri-tridecylamine, tri-tetradcylamine, tri-pentadecylamine, tri-hexadecylamine, tri-heptadecylamine, tri-octadecylamine; phosphines tri-octylphosphine, tri-butylphosphine; phosphonates such as octadecylphosphonate, hexadecylphosphonate, phenylphosponate.

In some embodiments of the present invention, said III-V semiconductor nanosized materials with the diameter standard deviation 13% or less, with preferably being of the diameter standard deviation in the range from 10% or less, more preferably it is from 10% to 1%, even more preferably, from 10% to 5%.

In another aspect, the present invention also relates to a III-V semiconductor nanosized material obtainable or obtained from the method for synthesizing the III-V semiconductor nanosized material, wherein the method comprises following steps,

(a) providing either a III-V semiconductor nanosized cluster and a first ligand at the same time or each separately,

or a III-V semiconductor nanosized cluster comprising a second ligand wherein the content of said second ligand is in the range from 40% to 80% by weight, more preferably in the range from 50% to 70% by weight, even more preferably from 55% to 65% by weight with respect to the total weight of the III-V semiconductor nanosized cluster,

to an another compound or to an another mixture of compounds, in order to get a reaction mixture,

(b) adjusting or keeping the temperature of the reaction mixture obtained in step (a) in the range from 250° C. to 500° C., with preferably being of the temperature in the range from 280° C. to 450° C., more preferably it is from 300° C. to 400° C., further more preferably from 320° C. to 380° C. to allow a creation and growth of a III-V semiconductor nanosized material in the mixture.

(c) cooling the reaction mixture to stop the growth of said III-V semiconductor nanosized material in step (b).

In some embodiments of the present invention, wherein the cooling rate in step (c) is in the range from 130° C./s to 5° C./s, preferably it is from 120° C./s to 10° C./s, more preferably it is from 110° C./s to 50° C./s, even more preferably it is from 100° C./s to 70° C./s.

More details of the method are described in the section of “Method for synthesizing III-V semiconductor nanosized materials”.

In some embodiments of the present invention, the value of the ratio of the exciton absorption peak (hereto referred to as the “OD_{Max}”) and the minimum following it on the blue side of the absorption spectra measured in a spectrometer, Shimadzu UV-1800, (hereto referred to as the “OD_{Min}”) from now on referred to as the OD_{Max}/OD_{Min} ratio, of said semiconductor nanosized material, preferably it is said semiconductor nanosized material for a semiconductor green light emitting nanosized material, based on absorption spectra between 460 nm and 630 nm measured in a spectrometer is >1.4 preferably is >1.6, more preferably >1.7, even more preferably >1.8.

Thus, in some embodiments of the present invention, the value of the ratio of the exciton absorption peak and the exciton absorption minimum of said semiconductor nanosized material, is 1.4 or more, preferably is 1.6 or more, more preferably 1.7 or more, even more preferably 1.8 or more.

In some embodiments of the present invention, the value of the ratio of the exciton absorption peak and the exciton absorption minimum of said semiconductor nanosized material, is preferably is in the range from 1.6 to 2.0.

In another aspect, the present invention further relates to a plurality of III-V semiconductor nanosized materials with the diameter standard deviation 13% or less, with preferably being of the diameter standard deviation in the range from 10% or less, more preferably it is from 10% to 1%, even more preferably, from 10% to 5%.

In a preferred embodiment of the present invention, the average size of the overall structures of the III-V semiconductor nanosized material is in the range from 0.5 nm to 50 nm. More preferably it is from 1.1 nm to 10 nm, even more preferably, it is from 1.3 nm to 5 nm from the viewpoint of desired quantum size effect.

According to the present invention, to observe average diameter of the obtained semiconductor nanosized materials and to calculate the diameter standard deviation, a Transmission Electron Microscopy (herein after “TEM”) image observation is used. To calculate the diameter standard deviation of the semiconductor nanosized materials, the diameter of 200 III-V semiconductor nanosized materials obtained in step (c) of the method for synthesizing III-V semiconductor nanosized materials, are measured with a Tecnai G2 Spirit Twin T-12 transmission electron microscope.

According to the present invention, the diameter standard deviation is a corrected diameter standard deviation represented by following formula.

$$σ = \sqrt{\frac{1}{( n - 1 )} {\sum }_{i = 1}^{n} {( xi - \overline{x} )}^{2}}$$

Wherein the formula, x̅ is the mean of the samples, σ means a (sample) diameter standard deviation, n is a total number of the samples.

The relative standard deviation (RSD) is:

RSD=(Sigma/Mean)*100

In another aspect, the present invention furthermore relates to semiconductor light emitting nanosized material comprising the III-V semiconductor nanosized material and a shell layer, preferably the shell layer consists of single shell layer, double shell layers or multi shell layers.

In a preferred embodiment of the present invention, said semiconductor light emitting nanosized material emits green light.

In some embodiments of the present invention, the Full Width at Half Maximum (FWHM) value of said semiconductor light emitting nanosized material, preferably it is green light emitting semiconductor light emitting nanosized material based on light emission spectra between 460 nm and 630 nm measured in a spectrometer, is <40 nm, preferably is <37 nm, more preferably in the range from 37 nm to 30 nm, more preferably <35 nm, even more preferably <32 nm, further more preferably <30 nm.

According to the present invention, a type of shape of the core of the nanosized light emitting material, and shape of the nanosized light emitting material to be synthesized are not particularly limited.

For examples, spherical shaped, elongated shaped, star shaped, polyhedron shaped, pyramidal shaped, tetrapod shaped, tetrahedron shaped, platelet shaped, cone shaped, and irregular shaped nanosized light emitting materials can be synthesized.

Shell Layer

According to the present invention, the semiconductor light emitting nanosized material comprises a core/shell structure.

According to the present invention, the term “core/shell structure” means the structure having a core part and at least one shell part covering fully or partially the said core. Preferably, said shell part fully covers said core. The term “core” and “shell” are well known in the art and typically used in the field of quantum materials.

In some embodiments of the present invention, said core/shell structure can be core/one shell layer structure, core/double shells structure or core/multishells structure.

According to the present invention, the term “multishells” stands for the stacked shell layers consisting of three or more shell layers.

Each stacked shell layers of double shells and/or multishells can be made from same or different materials.

In some embodiments of the present invention, said shell comprises group 12 and group 16 elements of the periodic table.

For example, as a core/shell structure, InP/CdS, InP/CdSe, InP/ZnS, InP/ZnSe, InP/ZnS/ZnSe, InP/ZnSe/ZnS, InP/ZnSeS, InP/ZnSeS/ZnS, InAs/CdS, InAs/CdSe, InAs/ZnS, InAs/ZnSe, InAs/ZnS/ZnSe, InAs/ZnSe/ZnS, InSb/CdS, InSb/CdSe, InSb/ZnS, InSb/ZnSe, InSb/ZnS/ZnSe, InSb/ZnSe/ZnS, GaP/CdS, GaP/CdSe, GaP/ZnS, GaP/ZnSe, GaP/ZnS/ZnSe, GaP/ZnSe/ZnS, GaAs/CdS, GaAs/CdSe, GaAs/ZnS, GaAs/ZnSe, GaAs/ZnS/ZnSe, GaAs/ZnSe/ZnS, GaSb/CdS, GaSb/CdSe, GaSb/ZnS, GaSb/ZnSe, GaSb/ZnS/ZnSe, GaSb/ZnSe/ZnS, InGaP/CdS, InGaP/CdSe, InGaP/ZnS, InGaP/ZnSe, InGaP/ZnS/ZnSe, InGaP/ZnSe/ZnS, InPZnS/ZnSe/ZnS, InPZnS/ZnSeS/ZnS, InPAs/CdS, InPAs/CdSe, InPAs/ZnS, InPAs/ZnSe, InPAs/ZnS/ZnSe, InPAs/ZnSe/ZnS, can be used preferably.

More preferably, it is selected from InP/ZnS, InP/ZnSe, InP/ZnS/ZnSe, InP/ZnSe/ZnS, InP/ZnSeS, InP/ZnSeS/ZnS, InAs/ZnS, InAs/ZnSe, InAs/ZnS/ZnSe, InAs/ZnSe/ZnS, InSb/ZnS, InSb/ZnSe, InSb/ZnS/ZnSe, InSb/ZnSe/ZnS, GaP/ZnS, GaP /ZnSe, GaP/ZnS/ZnSe, GaP/ZnSe/ZnS, GaAs/ZnS, GaAs/ZnSe, GaAs/ZnS/ZnSe, GaAs/ZnSe/ZnS, GaSb/ZnS, GaSb/ZnSe, GaSb/ZnS/ZnSe, GaSb/ZnSe/ZnS, InGaP/ZnS, InGaP/ZnSe, InGaP/ZnS/ZnSe, InGaP/ZnSe/ZnS, InPZnS/ZnSe/ZnS, InPZnS/ZnSeS/ZnS, InPAs/ZnS, InPAs/ZnSe, InPAs/ZnS/ZnSe, InPAs/ZnSe/ZnS, with even more preferably being of InP/ZnS, InP/ZnSe, InP/ZnS/ZnSe, InP/ZnSe/ZnS, InAs/ZnS, InAs/ZnSe, InAs/ZnS/ZnSe, InAs/ZnSe/ZnS

According to the present invention, a type of shape of the core and a type of lattice of the core are not particularly limited.

For examples, spherical shaped, elongated shaped, star shaped, polyhedron shaped, pyramidal shaped, tetrapod shaped, tetrahedron shaped, platelet shaped, cone shaped, and irregular shaped core materials, a core having Zinc Blende lattice, or a poly-lattice of Zinc Blende and Wurtzite can be used.

Cation Precursors for Shell Layer Coating

According to the present invention, as a cation precursor for shell layer coating, known cation precursor for shell layer synthesis comprising group 12 element of the periodic table or 13 element of the periodic table can be used.

For example, one or more members of the group consisting of Zn-oleate, Zn-carboxylate, Zn-acetate, Zn-myristate, Zn-stearate, Zn-undecylenate, Zn-acetate-alkylamine complexes, Zn-phosphonate, ZnCl₂, Cd-oleate, Cd-carboxylate, Cd-acetate, Cd-myristate, Cd-stearate and Cd-undecylenate, Cd-phosphonate, CdCl₂, Ga-oleate, Ga-carboxylate, Ga-acetate, Ga-myristate, Ga-stearate, Ga-undecylenate, Ga-acetlyacetanote can be used, with more preferably being of one or more members of the group consisting of Zn-oleate, Zn-carboxylate, Zn-acetate, Zn-myristate, Zn-stearate, Zn-undecylenate and Zn-acetate-oleylamine complexes can be used preferably in the shell layer coating process to coat said shell layer(s) onto the core.

More preferably, Zn oleate can be used as a cation precursor for ZnSe or ZnS shell layer coating.

Anion precursors for Shell Layer Coating

According to the present invention, as an anion precursor for shell layer coating, known anion precursor for shell layer synthesis comprising a group 16 element of the periodic table or a group 15 element of the periodic table can be used.

For example, as an anion precursor for shell layer coating can be selected from one or more members of the group consisting of Se anion: Se, Se-trioctylphopshine, Se-tributylphosphine, Se-oleylamine complex, Selenourea, Se-octadecene complex, Se-octadecene suspension, and thiols such as octanethiol, S anion: S, S-trioctylphopshine, S-tributylphosphine, S-oleylamine complex, Selenourea, S-octadecene complex, and S-octadecene suspension, tris(trimethylsilyl)phosphine, tris(diethylamino)phosphine, and tris(dimethylamino)phosphine can be used preferably.

More preferably, said anion and cation precursors for shell layer synthesis are added alternately during the synthesis, while the temperature of the solution in the synthesis increases from 180° C. and finishing at 320° C.

In some embodiments of the present invention, the shell layer thickness of the nanosized light emitting material obtained in step (c) can be 0.8 nm or more. Preferably, it is in the range from 0.8 nm to 10 nm. In a preferred embodiment, it is in the range from 1 nm to 4 nm. More preferably, it is in the range from 1.5 nm to 3 nm, where a thicker shell is required for applications.

In some embodiments of the present invention, the total shell layer thickness of the nanosized light emitting material can be in the range from 0.3 nm to 0.8 nm from the viewpoint of better energy transfer from the shell layer to said core.

By changing reaction time, total amount of precursors, the thickness of the shell layer can be controlled.

Shell coating step can be performed like described in U.S. Pat. No. 8,679,543 B2 and Chem. Mater. 2015, 27, pp 4893-4898.

In some embodiments of the present invention, the semiconductor light emitting nanosized material comprises surface ligands.

In a preferred embodiment of the present invention, the surface of the outermost shell layer of the semiconductor light emitting nanosized material can be over coated with one or more kinds of surface ligands.

In a preferred embodiment of the present invention, the surface ligands are attached onto the outermost surface of the shell layers.

Without wishing to be bound by theory it is believed that such a surface ligands may lead to disperse the semiconductor light emitting nanosized material in a solution more easily and also leads high Quantum Yield of the semiconductor light emitting nanosized material.

The surface ligands in common use include phosphines and phosphine oxides such as Trioctylphosphine oxide (TOPO), Trioctylphosphine (TOP), and Tributylphosphine (TBP); phosphonic acids such as Dodecylphosphonic acid (DDPA), Tridecylphosphonic acid (TDPA), Octadecylphosphonic acid (ODPA), and Hexylphosphonic acid (HPA); amines such as Oleylamine, Dedecyl amine (DDA), Tetradecyl amine (TDA), Hexadecyl amine (HDA), and Octadecyl amine (ODA), Oleylamine (OLA), thiols such as hexadecane thiol and hexane thiol; mercapto carboxylic acids such as mercapto propionic acid and mercaptoundecanoicacid; carboxylic acids such as oleic acid, stearic acid, myristic acid; acetic acid, zinc carboxylates such as zinc oleate and a combination of any of these. And also. Polyethylenimine (PEI) also can be used preferably.

Examples of surface ligands have been described in, for example, the laid-open international patent application No. WO 2012/059931A.

In some embodiments of the present invention, known core cleaning process can be applied before said shell coating.

Core Cleaning Process

In a preferred embodiment of the present invention, by mixing the obtained solution from step (c) and a cleaning solution of the present invention, unreacted core precursors and ligands in said solution from step (a) can be removed.

Cleaning Solution

In some embodiments of the present invention, the cleaning solution for step (d) comprises one solution selected from one or more members of the group consisting of ketones, such as, methyl ethyl ketone, acetone, methyl amyl ketone, methyl isobutyl ketone, and cyclohexanone; alcohols, such as, methanol, ethanol, propanol, butanol, hexanol, cyclo hexanol, ethylene glycol; hexane; chloroform; acetonitrile; xylene and toluene.

In a preferred embodiment of the present invention, the cleaning solution is selected from one or more members of the group consisting of ketones, such as, methyl ethyl ketone, acetone, methyl amyl ketone, methyl isobutyl ketone, and cyclohexanone; alcohols, such as, methanol, ethanol, propanol, butanol, hexanol, cyclo hexanol, ethylene glycol; hexane; chloroform; acetonitrile; xylene and toluene.

In a preferred embodiment of the present invention, to more effectively remove unreacted core precursors from the solution obtained in step (c) and remove the ligands leftovers in the solution, cleaning solution comprises one or more of alcohols is used.

More preferably, the cleaning solution contains one or more of alcohols selected from the group consisting of acetonitrile, methanol, ethanol, propanol, butanol, and hexanol, and one more solution selected from xylene or toluene to remove unreacted core precursors from the solution obtained in step (c) and remove the ligands leftovers in the solution effectively.

More preferably, the cleaning solution contains one or more of alcohols selected from methanol, ethanol, propanol, and butanol, and toluene.

In some embodiments of the present invention, the mixing ratio of alcohols:toluene or xylene can be 1:1-20:1 in a molar ratio. Preferably it is 5:1-10:1 to remove unreacted core precursors from the solution obtained in step (a) and to remove the ligands leftovers in the solution

More preferably, the cleaning removes the extra ligands and the unreacted precursor.

The most preferable embodiment of the present invention as a core cleaning is as follow.

1 equivalent of the crude solution is dispersed in 1 equivalent of toluene (by volume). Then, 8 equivalents (by volume) of ethanol are added to the solution. The resultant suspension is centrifuged for 5 min with the speed of 5000 rpm.

In another aspect, the present invention also relates to a method for synthesizing a semiconductor light emitting nanosized material comprising a core/shell structure, wherein the method comprises following steps (x), (y) and (z) in this sequence.

(x) synthesis of a core in a solution,

(y) removing the extra ligands from the core, and

(z) coating the core with at least one shell layer.

In some embodiments of the present invention, said shell comprises group 12 and group 16 elements of the periodic table and/or group 13 and group 15 elements of the periodic table.

More details of the step (x) is described in the section of “Method for synthesizing III-V semiconductor nanosized materials”.

More details of the shell layer and step (z) are described in the section of “shell layer”.

More details of step (y) is described in the section of “Core cleaning process”.

Semiconductor Light Emitting Nanosized Material

In another aspect, the present invention also relates to a semiconductor light emitting nanosized material obtainable from said method of the present invention.

Thus, the present invention relates to a method for synthesizing semiconductor light emitting nanosized material obtainable from the method comprising following steps (A), (B) and (C) in this sequence.

(A) synthesis of semiconducting core in a solution,

(B) adding anion precursor and cation precursor in a solution, preferably said cation precursor comprises group 12 element of the periodic table or 13 element of the periodic table, and said anion precursor comprises a group 16 element of the periodic table or a group 15 element of the periodic table,

(C) coating the core with at least one shell layer using said solution obtained in step (b).

More details of the said method are described in the section of “Method”.

Composition

In another aspect, the present invention further relates to composition comprising the semiconductor light emitting nanosized material according to the present invention, and at least one other material selected from the group consisting of organic light emitting materials, activators, inorganic fluorescent materials, charge transporting materials, scattering particles, and matrix materials.

For example, said activator can be selected from the group consisting of Sc³⁺, Y³⁺, La³⁺, Ce³⁺, Pr³⁺, Nd³⁺, Pm³⁺, Sm³⁺, Eu³⁺, Gd³⁺, Tb³⁺, Dy³⁺, Ho³⁺, Er³⁺, Tm³⁺, Yb³⁺, Lu³⁺, Bi³⁺, Pb²⁺, Mn²⁺, Yb²⁺, Sm²⁺, Eu²⁺, Dy²⁺, Ho²⁺ and a combination of any of these, and said inorganic fluorescent material can be selected from the group consisting of sulfides, thiogallates, nitrides, oxynitrides, silicated, aluminates, apatites, borates, oxides, phosphates, halophosphates, sulfates, tungstenates, tantalates, vanadates, molybdates, niobates, titanates, germinates, halides based phosphors, and a combination of any of these.

Such suitable inorganic fluorescent materials described above can be well known phosphors including nanosized phosphors, quantum sized materials like mentioned in the phosphor handbook, 2^{nd} edition (CRC Press, 2006), pp. 155-pp. 338 (W. M. Yen, S. Shionoya and H. Yamamoto), WO2011/147517A, WO2012/034625A, and WO2010/095140A.

According to the present invention, as said organic light emitting materials, charge transporting materials, any type of publically known materials can be used preferably. For example, well known organic fluorescent materials, organic host materials, organic dyes, organic electron transporting materials, organic metal complexes, organic hole transporting materials.

In a preferred embodiment of the present invention, as said matrix material, any type of publically known transparent matrix material, described in for example, WO 2016/134820A can be used.

For examples of scattering particles, small particles of inorganic oxides such as SiO₂, SnO₂, CuO, CoO, Al₂O₃ TiO₂, Fe₂O₃, Y₂O₃, ZnO, MgO; organic particles such as polymerized polystyrene, polymerized PMMA; inorganic hollow oxides such as hollow silica or a combination of any of these; can be used preferably.

Formulation

In another aspect, the present invention further relates to formulation comprising the semiconductor light emitting material or the composition, and at least solvent.

Preferably, said solvent is one or more of publically known solvents, described in for example, WO 2016/134820A.

Optical Medium

In another aspect, the present invention further relates to an optical medium comprising a semiconductor light emitting nanosized material.

In some embodiments of the present invention, the optical medium can be an optical sheet, for example, a color filter, color conversion film, remote phosphor tape, or another film or filter.

According to the present invention, the term “sheet” includes film and/or layer like structured mediums.

Optical Device

In another aspect, the invention further relates to an optical device comprising the optical medium.

In some embodiments of the present invention, the optical device can be a liquid crystal display device (LCD), Organic Light Emitting Diode (OLED), backlight unit for an optical display, Light Emitting Diode device (LED), Micro Electro Mechanical Systems (here in after “MEMS”), electro wetting display, or an electrophoretic display, a lighting device, and/or a solar cell.

### Preferable Embodiments of the Present Invention

1. Method for synthesizing a III-V semiconductor nanosized material, wherein the method comprises following steps,

(a) providing either a III-V semiconductor nanosized cluster and a first ligand at the same time or each separately,

or a III-V semiconductor nanosized cluster comprising a second ligand wherein the content of said second ligand is in the range from 40% to 80% by weight, more preferably in the range from 50% to 70% by weight, even more preferably from 55% to 65% by weight with respect to the total weight of the III-V semiconductor nanosized cluster,

to an another compound or to an another mixture of compounds, in order to get a reaction mixture,

(b) adjusting or keeping the temperature of the reaction mixture obtained in step (a) in the range from 250° C. to 500° C., with preferably being of the temperature in the range from 280° C. to 450° C., more preferably it is from 300° C. to 400° C., further more preferably from 320° C. to 380° C. to allow a creation and growth of a III-V semiconductor nanosized material in the mixture.

(c) cooling the reaction mixture to stop the growth of said III-V semiconductor nanosized material in step (b).

2. The method according to embodiment 1, wherein said another compound is a solvent.

3. The method according to embodiment 1 or 2, wherein the concentration of the ligand added in step (a) is larger than the concentration of the III-V semiconductor nanosized cluster with respect of the total concentration of the reaction mixture obtained in step (a).

4. The method according to any one of embodiments 1 to 3, wherein the III-V semiconductor nanosized cluster, which is provided with the first ligand in step (a), comprises a third ligand wherein the content of said third ligand is in the range from 40% to 80% by weight, more preferably in the range from 50% to 70% by weight, even more preferably from 55% to 65% by weight with respect to the total weight of the III-V semiconductor nanosized cluster.

5. The method according to any one of embodiments 1 to 4, wherein said first ligand is selected from one or more members of the group consisting of carboxylic acids, metal carboxylate ligands, phosphines, phosphonic acids, metal-phosphonates, amines, quaternary ammonium carboxylate salts, metal phosphonates and metal halides. with preferably being of myristic acid, lauric acid, stearate, oleate, myristate, laurate, phenyl acetate indium myristate, or indium acetate.

6. The method according to any one of embodiments 1 or 5, wherein said another compound is a solvent having the boiling point 250° C. or more, with preferably being of the boiling point in the range from 250° C. to 500° C., more preferably it is in the range from 300° C. to 480° C., even more preferably from 350° C. to 450° C., further more preferably it is from 370° C. to 430° C.

7. The method according to any one of embodiments 1 to 6, wherein said another compound is a solvent selected from one or more members of the group consisting of squalenes, squalanes, heptadecanes, octadecanes, octadecenes, nonadecanes, icosanes, henicosanes, docosanes, tricosanes, pentacosanes, hexacosanes, octacosanes, nonacosanes, triacontanes, hentriacontanes, dotriacontanes, tritriacontanes, tetratriacontanes, pentatriacontanes, hexatriacontanes, oleylamines, and trioctylamines, with preferably being of squalene, squalane, heptadecane, octadecane, octadecene, nonadecane, icosane, henicosane, docosane, tricosane, pentacosane, hexacosane, octacosane, nonacosane, triacontane, hentriacontane, dotriacontane, tritriacontane, tetratriacontane, pentatriacontane, hexatriacontane, oleylamine, and trioctylamine, more preferably squalane, pentacosane, hexacosane, octacosane, nonacosane, or triacontane, even more preferably squalane, pentacosane, or hexacosane.

8. The method according to any one of embodiments 1 to 7, wherein the total amount of the ligand added in step (a) is in the range from 0.2 to 50% by weight, with preferably being of 0.3 to 50% by weight, more preferably, 1-50% by weight, even more preferably, from 1 to 25% by weight, further more preferably it is from 5-25% by weight with respect to total weight of the reaction mixture.

9. The method according to any one of embodiments 1 to 8, wherein the temperature of the reaction mixture in step (b) is kept in the temperature range for from 1 second to 15 minutes with being more preferably from 1 second to 14 minutes, even more preferably, from 10 seconds to 12 minutes, further more preferably, from 10 seconds to 10 minutes, even more preferably, from 10 seconds to 5 minutes, the most preferably, from 10 seconds to 120 seconds.

10. The method according to any one of embodiments 1 to 9, wherein the total amount of the inorganic part of said III-V semiconductor nanosized clusters can be in the range from 0.1×10⁻⁴ to 1×10⁻³ mol %, with preferably being of the amount in the range from 0.5×10⁻⁴ to 5×10⁻⁴ mol %, more preferably from 1×10⁻⁴ to 3×10⁻⁴ mol % of the reaction mixture.

11. The method according to any one of embodiments 1 to 10, wherein the cooling rate in step (c) is in the range from 130° C./s to 5° C./s, preferably it is from 120° C./s to 10° C./s, more preferably it is from 110° C./s to 50° C./s, even more preferably it is from 100° C./s to 70° C./s.

12. The method according to any one of embodiments 1 to 11, wherein the first ligand and the III-V semiconductor nanosized cluster are provided to the another compound or to the another mixture of compounds at the same time in step (a).

13. The method according to any one of embodiments 1 to 12, wherein step (a) comprises following steps (a1) and (a2),

(a1) preparing a first mixture by mixing the first ligand and the III-V semiconductor nanosized cluster with an another compound or with an another mixture of compounds,

(a2) mixing the first mixture obtained in step (a1) with an another compound or with an another mixture at the temperature in the range between from 250° C. to 500° C., with preferably being of the temperature in the range from 280° C. to 450° C., more preferably it is from 300° C. to 400° C., further more preferably from 320° C. to 380° C. in order to get the reaction mixture.

14. The method according to any one of embodiments 1 to 11, wherein the first ligand and the III-V semiconductor nanosized cluster are provided into said another compound or into said another mixture separately in step (a), and the step (a) comprises following steps (a3) and (a4).

(a3) providing the first ligand into said another compound or into said another mixture of compounds,

(a4) providing the III-V semiconductor nanosized cluster into said another compound or into said another mixture of compounds in order to get the reaction mixture.

15. The method according to any one of embodiments 1 to 11, or 14, wherein the first ligand and the III-V semiconductor nanosized cluster are provided into said another compound or into said another mixture separately in step (a), and the step (a) comprises following steps (a3) and (a4) in this sequence.

(a3) providing the first ligand into said another compound or into said another mixture of compounds, (a4) providing the III-V semiconductor nanosized cluster into said another compound or into said another mixture of compounds in order to get the reaction mixture.

16. The method according to any one of embodiments 1 to 11, or 14, wherein the first ligand and the III-V semiconductor nanosized cluster are provided into said another compound or into said another mixture separately in step (a), and the step (a) comprises following steps (a4) and (a3) in this sequence.

(a4) providing the III-V semiconductor nanosized cluster into said another compound or into said another mixture of compounds,

(a3) providing the first ligand into said another compound or into said another mixture of compounds in order to get the reaction mixture.

17. The method according to any one of embodiments 1 to 16, wherein said III-V semiconductor nanosized cluster is a III-V magic sized cluster selected from the group consisting of InP, InAs, InSb, GaP, GaAs, and GaSb, InGaP, InPAs, InPZn, magic sized clusters, with preferably being InP magic sized cluster, more preferably, it is In₃₇P₂₀(O₂CR¹)₅₁, wherein said R¹ of said In₃₇P₂₀R¹₅₁is —O₂CCH₂Phenyl, or a substituted or unsubstituted fatty acid such as hexanoate, heptanoate, octanoate, nonanoate, decanoate, undecanoate, dodecanoate, tridecanoate, tetradecanoate, pentadecanoate, hexadecanoate, heptadecanoate, octadecanoate, nonadecanoate, icosanoate or oleate.

18. The method according to any one of embodiments 1 to 17, wherein said second ligand and said third ligand are, dependently or independently of each other, selected from one or more members of the group consisting of carboxylic acids, metal carboxylate ligands, phosphines, phosphonic acids, metal-phosphonates, amines, quaternary ammonium carboxylate salts, metal phosphonates and metal halides, with preferably being of myristic acid, lauric acid, stearate, oleate, myristate, laurate, phenyl acetate indium myristate, or indium acetate.

19. A III-V semiconductor nanosized material obtainable or obtained from the method according to any one of embodiments 1 to 18.

20. The III-V semiconductor nanosized material according to embodiment 19, wherein the value of the ratio of the exciton absorption peak and the exciton absorption minimum of said semiconductor nanosized material, is 1.4 or more, preferably is 1.6 or more, more preferably 1.7 or more, even more preferably 1.8 or more.

21. A plurality of III-V semiconductor nanosized materials with the diameter standard deviation 13% or less, with preferably being of the diameter standard deviation in the range from 10% or less, more preferably it is from 10% to 1%, even more preferably, from 10% to 5%.

22. A semiconductor light emitting nanosized material comprising the III-V semiconductor nanosized material according to any one of embodiments 19 to 21, and a shell layer, preferably the shell layer consists of single shell layer, double shell layers or multi shell layers.

23. The semiconductor light emitting nanosized material according to embodiment 22, wherein the Full Width at Half Maximum value of said semiconductor light emitting nanosized material is <40 nm, preferably is <37 nm, more preferably in the range from 37 nm to 30 nm, more preferably <35 nm, even more preferably <32 nm, further more preferably <30 nm.

24. A composition comprising the semiconductor light emitting nanosized material according to embodiment 22 or 23, and at least one other material selected from the group consisting of organic light emitting materials, inorganic light emitting materials, charge transporting materials, scattering particles, and matrix materials.

25. A formulation comprising the semiconductor light emitting nanosized material according to embodiment 22 or 23, or composition according to embodiment 24, and at least one solvent.

26. An optical medium comprising the semiconductor light emitting nanosized material according to embodiment 22 or 23.

27. An optical device comprising the optical medium according to embodiment 26.

### Effects of the Invention

The present invention provides:

1. a novel method for synthesizing III-V semiconductor nanosized materials without directly using the highly reactive tris(trimethylsilyl)phosphine;

2. a novel method for synthesizing III-V semiconductor nanosized materials, which can produce III-V semiconductor nanosized materials with improved size distribution;

3. a novel method for synthesizing III-V semiconductor nanosized materials without directly using the highly reactive tris(trimethylsilyl)phosphine, over which there is control of the particle size over a larger range such that green and/or red III-V semiconductor nanosized materials with improved size distribution can be produced;

4. a novel semiconductor light emitting nanosized material, which can emit light with better Full Width at Half Maximum (FWHM);

5. a novel semiconductor light emitting nanosized material, which can show improved quantum yield; and/or

6. an optical display device, whose optically active component is a semiconductor light emitting nanosized material, that gives an improved color purity and color gamut.

Definition of Terms

The term “semiconductor” means a material that has electrical conductivity to a degree between that of a conductor (such as copper) and that of an insulator (such as glass) at room temperature. Preferably, a semiconductor is a material whose electrical conductivity increases with the temperature.

The term “nanosized” means the size in between 0.1 nm and 999 nm.

The term “emission” means the emission of electromagnetic waves by electron transitions in atoms and molecules.

According to the present invention, the term “inorganic” means elements, which do not contain any carbon atom.

According to the present invention, the term “quantum sized” means the size of the semiconducting material itself without ligands or another surface modification, which can show the quantum confinement effect, like described in, for example, ISBN:978-3-662-44822-9.

According to the present invention, the term “magic sized clusters” means nanosized clusters which potential energy is lower than another nanosized clusters as described in J. Am. Chem. Soc. 2016, 138, 1510-1513, Chem. Mater. 2015, 27, 1432-1441, Xie, R. et al., J. Am. Chem. Soc., 2009, 131 (42), pp 15457-1546.

The example 1 and the working examples 1 to 2 below provide description of the present invention, as well as an in detail description of their fabrication.

### EXAMPLES

### Example 1

### Fabrication of a Nanosized Light Emitting Material

Fabrication of III-V Semiconductor Nanosized Materials

As the first ligand, myristic acid or Indium Myristate is added into squalane. The amount of the ligands is in the range from range from 1-50% by weight of 2.5 ml of the solvent. Preferably, it is from 1 to 25% by weight, more preferably it is from 5-25% by weight with respect to total weight of the reaction mixture.

Then, the solution with the ligands is heated up to the temperature in the range from 250° C. to 500° C., with preferably being of the temperature in the range from 280° C. to 450° C., more preferably it is from 300° C. to 400° C., further more preferably from 320° C. to 380° C., the most preferably, it is 350° C.

Then, 1 mL of solution of InP Magic sized clusters (1 to 400 mg acc. to Chem. Mater. 2015, 27, 1432-1441) dissolved in squalane, is injected into the solution.

The temperature of said solution is kept in the range from 250° C. to 500° C., with preferably being of the temperature in the range from 280° C. to 450° C., more preferably it is from 300° C. to 400° C., further more preferably from 320° C. to 380° C. for from 1 second to 15 minutes with being more preferably from 1 second to 14 minutes, even more preferably, from 10 seconds to 12 minutes, further more preferably, from 10 seconds to 10 minutes, even more preferably, from 10 seconds to 5 minutes, the most preferably, from 10 seconds to 120 seconds.

Then the solution is cooled rapidly either by adding room temperature solvent quickly or cooling flask that contains the solvent with a cooling bath to room temperature.

In addition, a sample is taken from the flask for a Transmission Electron Microscope (herein after “TEM”) image observation to observe average diameter of the obtained semiconductor nanosized materials and to calculate the diameter standard deviation. To calculate the diameter standard deviation of the semiconductor nanosized materials, 200 semiconductor nanosized materials obtained in the core synthesis process are measured with a Tecnai G2 Spirit Twin T-12 transmission electron microscope.

Shell Synthesis First, the III-V semiconductor nanosized materials obtained in the core synthesis are precipitated from solution by adding toluene and ethanol in a 1:4 ratio. The solution is then centrifuged to precipitate the quantum dots. These dots are then redissolved in 1-Octadecene (ODE) and heated up to 180° C. for 20 min.

Then, cation (1.2 mL of 0.4M Zn(acetate) in oleylamine and anion (0.275 mL of 2M TOP:Se or TOP:S) shell precursors are injected into the solution.

The solution is then heated by steps, followed by successive injections of cation (1.2 mL of 0.4M Zn(acetate) in oleylamine and anion (0.19 mL of 2M TOP:Se or TOP:S) shell precursors as described in table 1.

Finally, the obtained solution is cooled down to room temperature under inert conditions.

| | Time | | | | | | | |
|---|---|---|---|---|---|---|---|---|
| | 20 | 60 | 120 | 150 | 180 | 210 | 240 | 300 |
| | min | min | min | min | min | min | min | min |
| Temp. | 180° C. | 200° C. | 220° C. | 240° C. | 280° C. | 320° C. | 320° C. | 320° C. |
| Injection | anion and | | cation | anion | cation | anion | cation | end |
| | cation | | | | | | | |

At the end of the synthesis, the flask is cooled to room temperature. And a sample is taken from the flask for a TEM image observation.

### Working Examples

### Working Example 1

### Fabrication of III-V Semiconductor Nanosized Materials

Fabrication of InP Magic Sized Clusters

0.93 g (3.20 mmol) of indium acetate and 2.65 g (11.6 mmol) of myristicacid are put into a 100 mL, 14/20, four-neck round-bottom flask equipped with a reflux condenser, septums and a tap between the flask and the condenser.

The apparatus is evacuated with stirring and heated to 100° C. The solution is allowed to off gas acetic acid under reduced pressure for 12 h at 100° C. to generate the In(MA)3 (MA=Myristate) solution. Afterward, the flask is filled with argon, and a 20 mL of dry toluene is added.

In a glove box, 465 μL of P(SiMe₃)₃ is dissolved in 10 mL of dry toluene in a vial with a septum; the In(MA)3 flask is brought up to 110° C. and the P(SiMe₃)₃ solution is injected. After 102 minutes from the dissolution of said 465 μL of P(SiMe₃)₃ in 10 mL of dry toluene in a vial with a septum indicated above, additional P(SiMe₃)₃ solution in toluene (containing 0.975 mL of toluene and 0.225 mL of P(SiMe₃)₃) is injected. After 129 minutes from the dissolvement of said 465 μL of P(SiMe₃)₃, another 0.5 mL of the P(SiMe₃)₃ solution is injected. After 174 minutes, the mantle is removed and the flask is cooled down. The toluene is evaporated off under reduced pressure and the InP Magic Sized Clusters (hereafter InP MSCs) are cleaned by using toluene and acetonitrile until the ligand content is around 60% by weight.

Fabrication of InP Semiconductor Nanosized Materials

2.5 mL of distilled squalane is put in glove box into a 50 mL, 14/20, four-neck round-bottom flask equipped with a reflux condenser, septums and a tap between the flask and the condenser.

The apparatus is evacuated with stirring and heated to 375° C. under argon.

The cleaned InP MSCs with a total weight of the ligand and the inorganic part of the InP MSCs is 10 mg, where around 60 wt % is the ligand (4 mg of solid part of the InP MSCs and 6 mg of myristate attached on to the InP MSCs). This solution is then injected into the flask at 375° C. After 40 seconds from the injection of the solution, the mantle is removed and the flask was quickly cooled down.

### Working Example 2

### TEM Image Obsevation and STDV Caluculation

At the end of the synthesis, after said cooling down in working example 1, A sample is taken from the flask for a Transmission Electron Microscope (herein after “TEM”) image observation to observe average diameter of the obtained semiconductor nanosized materials and to calculate the diameter standard deviation (hereafter STDV) and relative diameter standard deviation (relative STDV). To calculate the diameter standard deviation of the semiconductor nanosized materials, 200 semiconductor nanosized materials obtained in the core synthesis process are measured with a Tecnai G2 Spirit Twin T-12 transmission electron microscope.

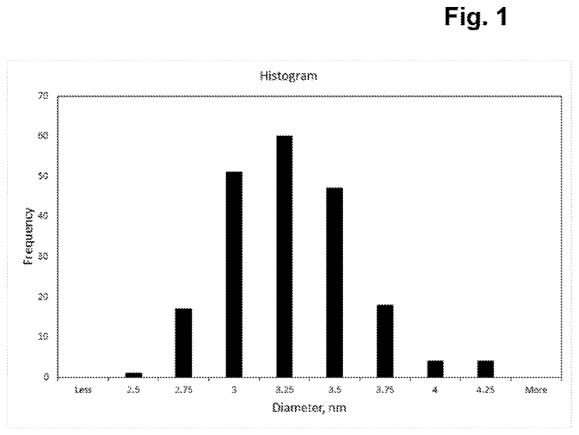

FIG. 1 shows histogram of the relative size distribution of obtained semiconductor nanosized materials and Table 1 shows calculation results of average diameter, STDV, and relative STDV of obtained semiconductor nanosized materials.

Said relative STDV is STDV/Average diameter*100%.

TABLE 1

| Average diameter (nm) | STDV σ (nm) | Relative STDV |
|---|---|---|
| 3.15 | 0.314 | 9.99% |

1. Method for synthesizing a III-V semiconductor nanosized material, wherein the method comprises following steps,
(a) providing either a III-V semiconductor nanosized cluster and a first ligand at the same time or each separately,
or a III-V semiconductor nanosized cluster comprising a second ligand wherein the content of said second ligand is in the range from 40% to 80% by weight, more preferably in the range from 50% to 70% by weight, even more preferably from 55% to 65% by weight with respect to the total weight of the III-V semiconductor nanosized cluster,
to an another compound or to an another mixture of compounds, in order to get a reaction mixture,
(b) adjusting or keeping the temperature of the reaction mixture obtained in step (a) in the range from 250° C. to 500° C., with preferably being of the temperature in the range from 280° C. to 450° C., more preferably it is from 300° C. to 400° C., further more preferably from 320° C. to 380° C. to allow a creation and growth of a III-V semiconductor nanosized material in the mixture.
(c) cooling the reaction mixture to stop the growth of said III-V semiconductor nanosized material in step (b).

2. The method according to claim 1, wherein said another compound is a solvent.

3. The method according to claim 1, wherein the concentration of the ligand added in step (a) is larger than the concentration of the III-V semiconductor nanosized cluster with respect of the total concentration of the reaction mixture obtained in step (a).

4. The method according to claim 1, wherein the III-V semiconductor nanosized cluster, which is provided with the first ligand in step (a), comprises a third ligand wherein the content of said third ligand is in the range from 40% to 80% by weight, more preferably in the range from 50% to 70% by weight, even more preferably from 55% to 65% by weight with respect to the total weight of the III-V semiconductor nanosized cluster.

5. The method according to claim 1, wherein said first ligand is selected from one or more members of the group consisting of carboxylic acids, metal carboxylate ligands, phosphines, phosphonic acids, metal-phosphonates, amines, quaternary ammonium carboxylate salts, metal phosphonates and metal halides with preferably being of myristic acid, lauric acid, stearate, oleate, myristate, laurate, phenyl acetate indium myristate, or indium acetate.

6. The method according to claim 1, wherein said another compound is a solvent having the boiling point 250° C. or more, with preferably being of the boiling point in the range from 250° C. to 500° C., more preferably it is in the range from 300° C. to 480° C., even more preferably from 350° C. to 450° C., further more preferably it is from 370° C. to 430° C.

7. The method according to claim 1, wherein said another compound is a solvent selected from one or more members of the group consisting of squalenes, squalanes, heptadecanes, octadecanes, octadecenes, nonadecanes, icosanes, henicosanes, docosanes, tricosanes, pentacosanes, hexacosanes, octacosanes, nonacosanes, triacontanes, hentriacontanes, dotriacontanes, tritriacontanes, tetratriacontanes, pentatriacontanes, hexatriacontanes, oleylamines, and trioctylamines, with preferably being of squalene, squalane, heptadecane, octadecane, octadecene, nonadecane, icosane, henicosane, docosane, tricosane, pentacosane, hexacosane, octacosane, nonacosane, triacontane, hentriacontane, dotriacontane, tritriacontane, tetratriacontane, pentatriacontane, hexatriacontane, oleylamine, and trioctylamine, more preferably squalane, pentacosane, hexacosane, octacosane, nonacosane, or triacontane, even more preferably squalane, pentacosane, or hexacosane.

8. The method according to claim 1, wherein the total amount of the ligand added in step (a) is in the range from 0.2 to 50% by weight, with preferably being of 0.3 to 50% by weight, more preferably, 1-50% by weight, even more preferably, from 1 to 25% by weight, further more preferably it is from 5-25% by weight with respect to total weight of the reaction mixture.

9. The method according to claim 1, wherein the temperature of the reaction mixture in step (b) is kept in the temperature range for from 1 second to 15 minutes with being more preferably from 1 second to 14 minutes, even more preferably, from 10 seconds to 12 minutes, further more preferably, from 10 seconds to 10 minutes, even more preferably, from 10 seconds to 5 minutes, the most preferably, from 10 seconds to 120 seconds.

10. The method according to claim 1, wherein the total amount of the inorganic part of said III-V semiconductor nanosized clusters is in the range from 0.1×10⁻⁴ to 1×10⁻³ mol %, with preferably being of the amount in the range from 0.5×10⁻⁴ to 5×10⁴ mol %, more preferably from 1×10⁻⁴ to 3×10⁻⁴ mol % of the reaction mixture.

11. The method according to claim 1, wherein the cooling rate in step (c) is in the range from 130° C./s to 5° C./s, preferably it is from 120° C./s to 10° C./s, more preferably it is from 110° C./s to 50° C./s, even more preferably it is from 100° C./s to 70° C./s.

12. The method according to claim 1, wherein the first ligand and the III-V semiconductor nanosized cluster are provided to the another compound or to the another mixture of compounds at the same time in step (a).

13. The method according to claim 1, wherein the first ligand and the III-V semiconductor nanosized cluster are provided into said another compound or into said another mixture separately in step (a), and the step (a) comprises following steps (a3) and (a4).
(a3) providing the first ligand into said another compound or into said another mixture of compounds,
(a4) providing the III-V semiconductor nanosized cluster into said another compound or into said another mixture of compounds in order to get the reaction mixture.

14. The method according to claim 1, wherein said second ligand and said third ligand are, dependently or independently of each other, selected from one or more members of the group consisting of carboxylic acids, metal carboxylate ligands, phosphines, phosphonic acids, metal-phosphonates, amines, quaternary ammonium carboxylate salts, metal phosphonates and metal halides, with preferably being of myristic acid, lauric acid, stearate, oleate, myristate, laurate, phenyl acetate indium myristate, or indium acetate.

15. A III-V semiconductor nanosized material obtainable or obtained from the method according to claim 1.

16. The III-V semiconductor nanosized material according to claim 15, wherein the value of the ratio of the exciton absorption peak and the exciton absorption minimum of said semiconductor nanosized material, is 1.4 or more, preferably is 1.6 or more, more preferably 1.7 or more, even more preferably 1.8 or more.

17. A plurality of III-V semiconductor nanosized materials with the diameter standard deviation 13% or less, with preferably being of the diameter standard deviation in the range from 10% or less, more preferably it is from 10% to 1%, even more preferably, from 10% to 5%.

18. A semiconductor light emitting nanosized material comprising the III-V semiconductor nanosized material according to claim 15, and a shell layer, preferably the shell layer consists of single shell layer, double shell layers or multi shell layers.

19. The semiconductor light emitting nanosized material according to claim 18, wherein the Full Width at Half Maximum value of said semiconductor light emitting nanosized material is <40 nm, preferably is <37 nm, more preferably in the range from 37 nm to 30 nm, more preferably <35 nm, even more preferably <32 nm, further more preferably <30 nm.

20. A composition comprising the semiconductor light emitting nanosized material according to claim 18, and at least one other material selected from the group consisting of organic light emitting materials, inorganic light emitting materials, charge transporting materials, scattering particles, and matrix materials.

21. A formulation comprising the semiconductor light emitting nanosized material according to claim 18 and at least one solvent.

22. An optical medium comprising the semiconductor light emitting nanosized material according to claim 18.

23. An optical device comprising the optical medium according to claim 22.
